(19) United States
(12) Patent Application Publication
(10) Pub. No.: US 2014/0097259 A1
(43) Pub. Date: Apr. 10, 2014

(54) THERMOSTAT

(71) Applicants: HYUNDAI MOTOR COMPANY, Seoul (KR); KIA MOTORS CORPORATION, Seoul (KR); INZICONTROLS CO. LTD., Siheung-si (KR)

(72) Inventors: Philgi LEE, Suwon-si (KR); Gyuhwan Kim, Suwon-si (KR); Jae Suk Park, Suwon-si (KR); Hee-Hwa Joung, Siheung-si (KR); Yong Jeong Kim, Ansan-si (KR)

(73) Assignees: Hyundai Motor Company, Seoul (KR); Inzicontrols Co. Ltd., Siheung-si (KR); Kia Motors Corporation, Seoul (KR)

(21) Appl. No.: 13/713,772

(22) Filed: Dec. 13, 2012

(30) Foreign Application Priority Data
Oct. 9, 2012 (KR) 10-2012-0111876

(51) Int. Cl. G05D 23/185

(52) U.S. Cl. CPC G05D 23/1852
USPC 236/101 C

(57) ABSTRACT

A thermostat apparatus may include a valve body including a first valve, a second valve, wherein the first valve may be integrally connected with the second valve , and a drive portion the drive portion includes a wax case that wax may be charged therein, a piston guide connected to a front end portion of the wax case, a piston that may be slidably inserted into the piston guide and movable in accordance with expansion or contraction of the wax, a semi-fluid that may be charged between the wax and the piston, and a rubber layer that may be formed on an upper end portion surface of the piston to seal a space the piston and an interior circumference of the piston guide.

### CROSS-REFERENCE TO RELATED APPLICATION

The present application claims priority to Korean Patent Application No. 10-2012-0111876 filed on Oct. 9, 2012, the entire contents of which is incorporated herein for all purposes by this reference.

### BACKGROUND OF THE INVENTION

1. Field of the Invention

The present invention relates to a thermostat that changes a passage of a coolant depending on the temperature of the coolant and actively controls the coolant temperature to prevent overheating thereof.

2. Description of Related Art

A thermostat for a vehicle is disposed between an engine and a radiator, is automatically opened/closed by the temperature variation of coolant to adjust the flow rate of the coolant, and therefore the temperature of the coolant is controlled in a predetermined range.

A mechanical thermostat expands wax depending on the temperature of the coolant, and the expanding force of the wax makes a piston move the valve of the thermostat.

The mechanical thermostat is operated in a predetermined opening/closing temperature of the coolant to open/close the valve only in a predetermined temperature condition, and therefore the mechanical thermostat does not actively move against changes of the driving circumstances of the vehicle.

Accordingly, an electrical thermostat has been introduced to complements the drawback of the mechanical thermostat, and the electrical thermostat is operated to sustain the coolant temperature in an optimized range.

The electrical thermostat actively controls the coolant temperature of the engine according to the driving circumstances such as the load level of the vehicle to sustain the optimized coolant temperature, and the electrical thermostat can improve fuel consumption efficiency and reduce exhaust gas.

A drive portion that is a temperature sensitive type and is electrically controlled has been applied to open or close the valve of a thermostat, and the drive portion includes wax, semi-fluid, a rubber piston, a back-up plate, and a main piston.

Here, the wax, the semi-fluid, the rubber piston, the back-up plate, and the main piston are sequentially disposed in a length direction, and the main piston is moved forward or backward by the expansion or the contraction of the wax.

As described above, because many kinds of components (wax, semi-fluid, rubber piston, back-up plate) are used for the drive portion, overall length becomes longer, and components and assembly cost are increased when the components are assembled.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a thermostat having advantages of reducing overall fabrication cost by reducing the number of components, the length of the assembled part, and component cost.

In an aspect of the present invention, a thermostat apparatus may include a valve body including a first valve formed at one side to open or close a first passage, a second valve formed at the other side to close or open a second passage, wherein the first valve is integrally connected with the second valve , and a drive portion that selectively pushes the valve body toward the second passage such that the first passage is opened by the first valve and the second passage is closed or the opening rate thereof is reduced by the second valve, wherein the drive portion may include a wax case that wax is charged therein, a piston guide connected to a front end portion of the wax case, a piston that is slidably inserted into the piston guide and movable in accordance with expansion or contraction of the wax, a semi-fluid that is charged between the wax and the piston, and a rubber layer that is formed on an upper end portion surface of the piston to seal a space the piston and an interior circumference of the piston guide.

A knurling portion is formed on the upper end portion surface of the piston, and the rubber layer is fixed on the knurling portion, and an upper surface of the rubber layer directly contacts the semi-fluid.

The thermostat apparatus may further include an elastic member that elastically biases the valve body toward the first passage direction such that the first valve closes the first passage and the second valve opens the second passage.

A mounting space is formed along a central portion of the valve body, the drive portion is inserted into the mounting space, and the piston of the drive portion pushes a piston support portion that is integrally formed at a central portion of the valve body.

The thermostat apparatus may further include a diaphragm that is disposed between the wax and the semi-fluid to be elastically deformed convexly toward the piston such that the semi-fluid pushes the piston downwards.

A diameter of the wax case is larger than a diameter of the piston guide.

In the thermostat according to an exemplary embodiment of the present invention, a drive portion may include a wax, a semi-fluid, and a rubber layer that is formed to be fixed on the main piston such that the number of the components is reduced and the overall length thereof becomes short.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a partial cross-sectional view of a thermostat that is provided on an engine according to an exemplary embodiment of the present invention.

FIG. 2 is a partial expanded cross-sectional view of a thermostat according to an exemplary embodiment of the present invention.

FIG. 3 is a side view showing a main piston of a thermostat according to an exemplary embodiment of the present invention.

FIG. 4 is an expanded cross-sectional view showing a part of a main piston of a thermostat according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

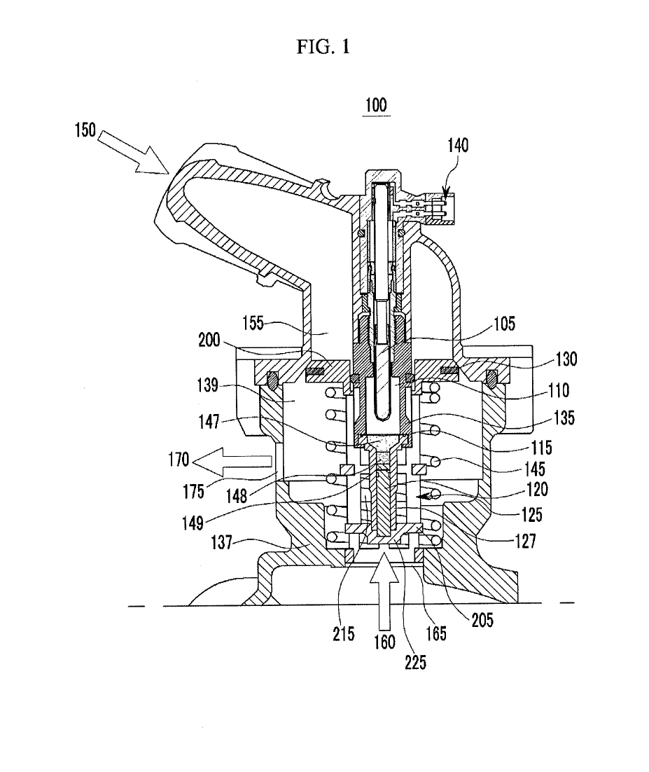

FIG. 1 is a partial cross-sectional view of a thermostat that is provided on an engine according to an exemplary embodiment of the present invention.

Referring to FIG. 1, an engine includes a radiator 150, a coolant outlet 160 of an engine, a coolant inlet 170 of an engine, and a thermostat 100.

The thermostat 100 includes a thermostat case 137, and a first passage 155 is formed to be connected to the radiator 150, a second passage 165 is formed to be connected to the coolant outlet 160, and a third passage 175 is connected to the coolant inlet 170 in the thermostat case 137.

A coolant pump in an exemplary embodiment of the present invention is disposed between the third passage 175 and the coolant inlet 170 to circulate coolant from the thermostat 100 to the engine.

As shown in drawings, the first passage 155 is formed at an upper side, the second passage 165 is formed at a lower side, and the third passage 175 is formed between the first and second passages 155 and 165.

A joining space 139 is formed in the thermostat case 137 to be connected to the first passage 155, the second passage 165, and the third passage 175, and a valve body 125 is disposed in the joining space 139.

A first valve 200 is integrally formed at an upper end portion of the valve body 125 to selectively close the first passage 155, and a second valve 205 is integrally formed at a lower end portion of the valve body 125 to selectively close the second passage 165. Further, a valve O-ring 130 is mounted along an exterior circumference of the first valve 200 to contact the interior circumference of the first passage 155.

A main spring 145 is disposed inside the thermostat case 137, and an upper end portion of the main spring 145 elastically supports the lower end portion of the first valve 200 in an upper direction, and a lower end portion of the main spring 145 is supported by an inner side of the thermostat case 137.

The main spring 145 has a coil spring structure, and the valve body is inserted into the coil of the main spring 145 except the first valve 200 and the part that that is inserted into the second passage 165.

Further, a mounting space is formed along a central portion of the valve body 125 from an upper end side to a lower end side, and a drive portion that moves the valve body 125 is inserted into the mounting space 215.

The drive portion includes a piston support portion 225, a piston guide 127, a main piston 120, a back-up plate 149, a rubber piston 148, a semi-fluid 147, a diaphragm 115, wax 110, a wax case 135, and a glow plug 105, wherein the glow plug 105 is electrically connected to a connector 140.

The piston support portion 225 is formed at a central portion of the second valve 205 that is formed at a lower end portion of the valve body 125.

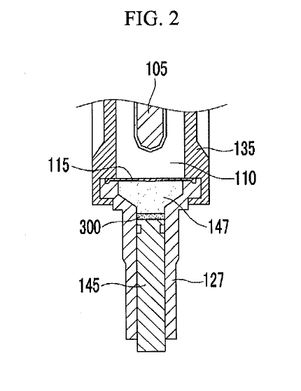

FIG. 2 is a partial expanded cross-sectional view of a thermostat according to an exemplary embodiment of the present invention.

Referring to FIG. 2, a drive portion that moves the main piston 120 includes a glow plug 105, a wax case 135, a wax 110, a diaphragm 115, semi-fluid 147, a rubber layer 300, a piston guide 127, and main piston 120.

As shown in the drawings, the rubber layer 300 is formed at an upper end surface of the main piston 120.

The rubber layer 300 is formed on the surface of the end portion of the main piston 120 to be fixed thereon and the layer 300 prevents the semi-fluid 147 from being leaked from the exterior circumference of the main piston 120 and the interior circumference of the piston guide 127.

The rubber layer 300 is formed on the end portion surface of the main piston 120 and the outside surface of the rubber layer 300 direct contacts the semi-fluid 147 that is charged at an upper portion thereof in an exemplary embodiment of the present invention.

Accordingly, a general rubber piston and a back-up plate are not disposed thereon, and the rubber layer 300 is substituted for them in an exemplary embodiment of the present invention such that the number of the components is reduced and the length of the drive portion becomes short.

Further, the production cost can be saved with the reduction of the number of the components.

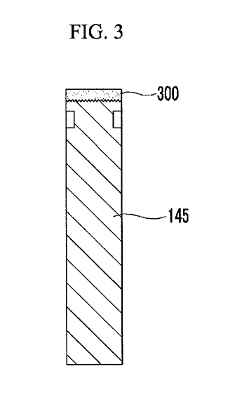

FIG. 3 is a side view showing a main piston of a thermostat according to an exemplary embodiment of the present invention.

Referring to FIG. 3, the rubber layer 300 is formed on the upper end surface of the main piston 120 to be fixed thereon. Accordingly, the rubber layer 300 and the main piston 120 are handled as one component to be able to save the assembling cost and the management cost.

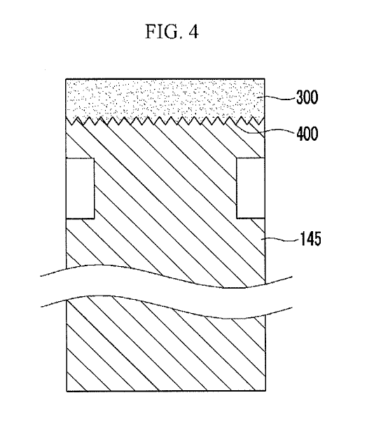

FIG. 4 is an expanded cross-sectional view showing a part of a main piston of a thermostat according to an exemplary embodiment of the present invention.

Referring to FIG. 4, a knurling portion 400 that having a rough surface is formed on the upper end surface of the main piston 120 and the knurling portion 400 increases the adhesive force between the rubber layer 300 and the main piston 120.

A resin for rubber is applied on the end portion surface of the main piston 120 in which the knurling portion 400 is formed thereon and the resin can be hardened so as to form the rubber layer 300.

The rubber layer 300 is sturdily formed on the end portion surface of the main piston 120 through the above process.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A thermostat apparatus, comprising:
a valve body including:
a first valve formed at one side to open or close a first passage;
a second valve formed at the other side to close or open a second passage,
wherein the first valve is integrally connected with the second valve; and
a drive portion that selectively pushes the valve body toward the second passage such that the first passage is opened by the first valve and the second passage is closed or the opening rate thereof is reduced by the second valve,
wherein the drive portion includes:
a wax case that wax is charged therein;
a piston guide connected to a front end portion of the wax case;
a piston that is slidably inserted into the piston guide and movable in accordance with expansion or contraction of the wax;
a semi-fluid that is charged between the wax and the piston; and
a rubber layer that is formed on an upper end portion surface of the piston to seal a space the piston and an interior circumference of the piston guide.

2. The thermostat apparatus of claim 1,
wherein a knurling portion is formed on the upper end portion surface of the piston, and
wherein the rubber layer is fixed on the knurling portion, and an upper surface of the rubber layer directly contacts the semi-fluid.

3. The thermostat apparatus of claim 1, further including an elastic member that elastically biases the valve body toward the first passage direction such that the first valve closes the first passage and the second valve opens the second passage.

4. The thermostat apparatus of claim 1,
wherein a mounting space is formed along a central portion of the valve body,
wherein the drive portion is inserted into the mounting space, and
wherein the piston of the drive portion pushes a piston support portion that is integrally formed at a central portion of the valve body.

5. The thermostat apparatus of claim 1, further including a diaphragm that is disposed between the wax and the semi-fluid to be elastically deformed convexly toward the piston such that the semi-fluid pushes the piston downwards.

6. The thermostat apparatus of claim 1, wherein a diameter of the wax case is larger than a diameter of the piston guide.
